(19) United States
(12) Patent Application Publication
(10) Pub. No.: US 2021/0382479 A1
(43) Pub. Date: Dec. 9, 2021

(54) Systems and Methods for Controlling Automated Systems Using Integer Programming and Column Generation Techniques

(71) Applicants: Insurance Services Office, Inc., Jersey City, NJ (US); University of Southern California, Los Angeles, CA (US)

(72) Inventors: Naveed Haghani, Fulton, MD (US); Jiaoyang Li, Jiangsu (CN); Sven Koenig, Pasadena, CA (US); Gautam Kunapuli, Brooklyn, NY (US); Claudio Contardo, Montreal (PQ) (CA); Julian Yarkony, Jersey City, NJ (US)

(73) Assignees: Insurance Services Office, Inc., Jersey City, NJ (US); University of Southern California, Los Angeles, CA (US)

(21) Appl. No.: 17/343,612

(22) Filed: Jun. 9, 2021

Related U.S. Application Data
(60) Provisional application No. 63/036,600, filed on Jun. 9, 2020.

(51) Int. Cl. G05D 1/00; G05B 19/042; G05D 1/02; G01C 21/34

(52) U.S. Cl. CPC G05D 1/0088; G05B 19/042; G05B 2219/2637; G01C 21/3453; G05D 1/0212

(57) ABSTRACT

Systems and methods for controlling automated systems, such as robots and other devices/resources, using integer programming and column generation techniques, are provided. The system retrieves location and movement data corresponding to at least one automated system, and processes the location and movement data using an integer linear programming algorithm. The system also optimizes the integer linear programming algorithm using a column generation algorithm, and solves a pricing problem associated with generating routes for the at least one automated system. Then, the system generates a route based on outputs of the integer linear programming algorithm, the column generation algorithm, and solving of the pricing problem, and transmits the route to the at least one automated system, the at least one automated system executing the route to control a location or a movement of the at least one automated system.

### RELATED APPLICATIONS

This application claims priority to U.S. Provisional Patent Application Ser. No. 63/036,600 filed on Jun. 9, 2020, the entire disclosure of which is hereby expressly incorporated by reference.

### STATEMENT OF GOVERNMENT INTERESTS

This invention was made with government support under Contract Nos. 1409987, 1724392, 1817189, and 1837779 awarded by the National Science Foundation (NSF). The government has certain rights in the invention.

### BACKGROUND

### Technical Field

The present disclosure relates generally to the field of systems automation. More specifically, the present disclosure relates to systems and methods for controlling automated systems, such as robots and other devices/resources, using integer programming and column generation techniques.

### Related Art

In today's highly automated world, the ability to rapidly an efficiently control the routing and operations of automated systems, such as fleets of robots and other automated systems/resources, is highly beneficial. Being able to route and control routing and operations of such systems efficiently results in not only the efficient and timely completion of tasks, but also saving energy, reducing equipment wear, contributing to overall operational efficiency, and reducing costs. Such improvements are advantageous in a number of environments, including warehouses, logistics operations, manufacturing, supply chain fulfillment, and other environment where the rapid and accurate movement of objects in a facility are of utmost importance.

Numerous attempts have, in the past, been made to address efficient control of device routing, such as robots. For example, routing problems for a fleet of robots in a warehouse are often treated as Multi-Agent Pathfinding problems (MAPF). In MAPF, a set of agents are provided, each with an initial position and destination. The goal is to minimize the sum of the travel times from the initial position to the destination over all agents such that no collisions occur. MAPF can be formulated as a minimum cost multi-commodity ow problem on a space-time graph. Optimization can be addressed using multiple heuristic and exact approaches, including search, linear programming, branch-cut-and-price, satisfiability modulo theories, and constraint programming.

One common shortcoming in MAPF approaches is that they require that robot assignments be set before a robot route can be solved. The delegation of robot assignments and the optimal set of routes for the fleet are treated as independent problems. Several approaches solve this combined problem in a hierarchical framework, i.e., assigning tasks first by ignoring the non-colliding requirement and then planning collision-free paths based on the assigned tasks. However, these methods are non-optimal as the consideration of possible collisions can easily affect the optimal task assignment for the fleet.

Multi-robot planning (MRP) aims to route a fleet of robots in a warehouse so as to achieve the maximum reward in a limited amount of time, while not having the robots collide and obeying the constraints of individual robots. In MRP, individual robots may make multiple trips over a given time window and may carry multiple items on each trip. The efficiency of the warehouse, not the makespan, can be enhanced since new orders are likely to be continuously added. Additionally, linear programming (ILP) formulation and column generation (CG) techniques for (prize collecting) vehicle routing are also of interest in efficient robot planning, as is efficient optimization by avoiding consideration of every time increment.

Accordingly, what would be desirable are systems and methods for controlling automated systems, such as robots and other devices/resources, using integer programming and column generation techniques, which address the foregoing, and other, needs.

### SUMMARY

The present disclosure relates to systems and methods for controlling automated systems, such as robots and other devices/resources, using integer programming and column generation techniques. The system retrieves location and movement data corresponding to at least one automated system, and processes the location and movement data using an integer linear programming algorithm. The system also optimizes the integer linear programming algorithm using a column generation algorithm, and solves a pricing problem associated with generating routes for the at least one automated system. Then, the system generates a route based on outputs of the integer linear programming algorithm, the column generation algorithm, and solving of the pricing problem, and transmits the route to the at least one automated system, the at least one automated system executing the route to control a location or a movement of the at least one automated system.

### BRIEF DESCRIPTION OF THE DRAWINGS

The foregoing features of the invention will be apparent from the following Detailed Description, taken in connection with the accompanying drawings, in which:

FIG. 1 is a diagram illustrating hardware and software components of the system of the present disclosure;

FIG. 2 is a flowchart illustrating processing steps carried out by the system of FIG. 1;

FIG. 3 is a table illustrating an optimization algorithm executed by the systems and methods of the present disclosure, utilizing a column generation technique;

FIG. 4 is a table illustrating a fast pricing algorithm executed by the systems and methods of the present disclosure;

FIG. 5 is a graph illustrating sample routes generated by the systems and methods of the present disclosure; and

FIG. 6 is a graph illustrating performance of the systems and methods of the present disclosure.

### DETAILED DESCRIPTION

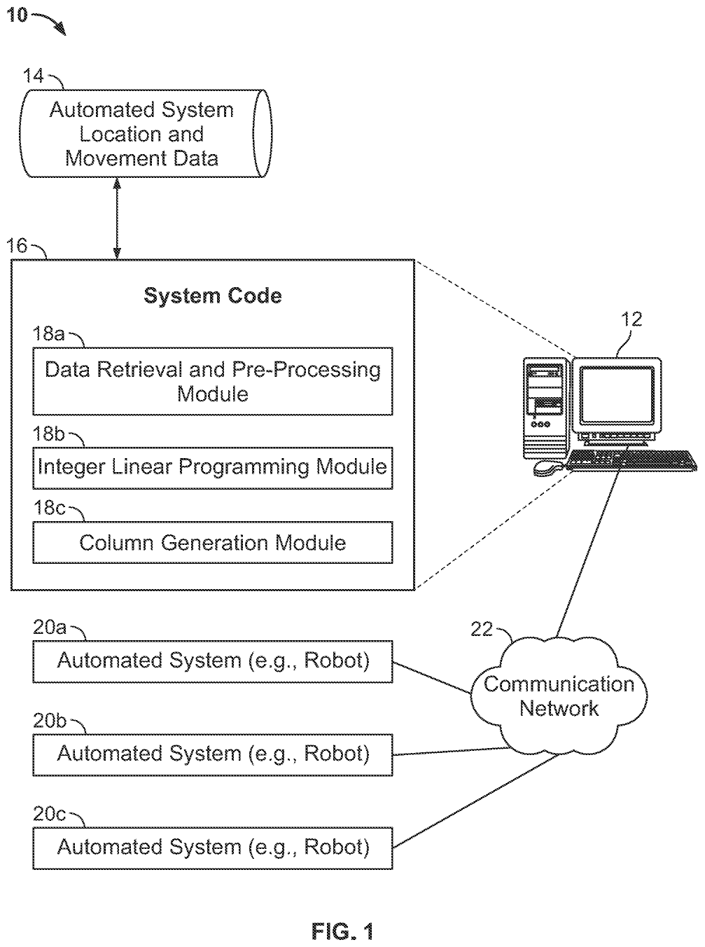

The present disclosure relates to systems and methods for controlling automated systems, such as robots and other devices/resources, using integer programming and column generation techniques, as discussed in detail below in connection with FIGS. 1-6.

FIG. 1 is a diagram illustrating overall hardware and software components of the system of the present disclosure, indicated generally at 10. The system 10 includes system code 16 that is executable by a processor of a computer system 12 and retrieves location and movement data from a data source such as a database 14. The location and movement data corresponds to locations and movements of one or more automated systems 20a-20c, which could include, but are not limited to, robots, automatic guided vehicles (AGVs), drones, or other system/resource. The automated systems 20a-20c could be in communication with the computer system 12 using a suitable communication network 22, such as a wide area network (WAN), local area network (LAN), controller area network (CAN), wireless network, optical network, infrared network, cellular data network, or other suitable network connections.

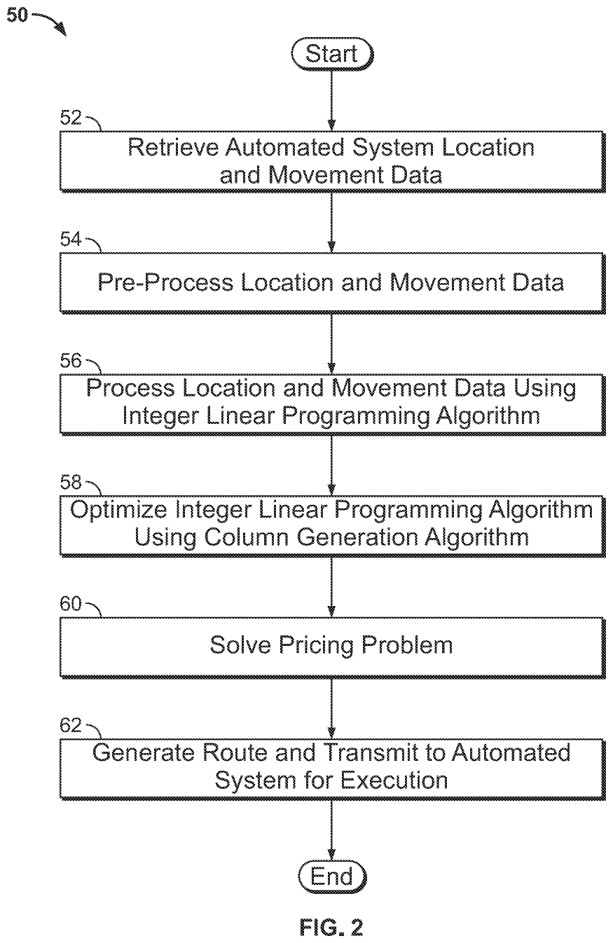

The system code 16 includes a plurality of software modules 18a-18c including a data retrieval and pre-processing module 18a, an integer linear programming module 18b, and a column generation module 18c, each of which are described in greater detail below in connection with FIG. 2 and provide the automated system routing and control operations described herein. The system code 16 could be programmed in any suitable high- or low-level language such as C, C++, C#, Java, Python, or any other suitable programming language. The computer system 12 could include, but is not limited to, a personal computer, a tablet computer, a smart phone, a server, or any other suitable computing device. Moreover, the computer system 12 could be an embedded processor of a robot, robot control system, automation system, automated guided vehicle (AGV) (such as in one or more processors of the automated systems 20a-20c), or a custom-developed hardware device such as an application-specific integrated circuit (ASIC), field-programmable gate array (FPGA), or any other suitable hardware device.

The location and movement data stored in the database 14 could be accumulated location and movement data associated with one or more automated systems, such as robots, AGVs, or other automated systems capable of moving from one location to another. Such data could also be provided in real time to the system code 16, e.g., transmitted to the computer system 12 in real time from the one or more automated systems. The module 18a retrieves the data (e.g., from the database 14, or in real time from the automated systems) and pre-processes the data as needed (e.g., formatting location and movement data into common units, coordinate systems, formats, etc.). Then, the data is processed by the modules 18b-18c to generate optimized routing plans for the one or more automated systems, as described in greater detail below in connection with FIG. 2.

The system 10 could operate with a fleet of mobile warehouse robots that enter the warehouse floor from a single location, called the launcher, pick up one or multiple items inside the warehouse, and deliver them to the launcher before the time limit. Each item has a reward (i.e., negative cost) and a time window during which the item can be picked up. Each robot has a capacity and is allowed to perform multiple trips. At the initial time, the fleet of robots is located at the launcher, however we also allow for some robots, called extant robots, to begin at other locations. The use of extant robots permits re-optimization as the environment changes, e.g. when items have their rewards changed or when items are added or removed. The goal is to plan collision-free paths for the robots to pick up and deliver items and minimize the overall cost.

For computational efficiency, the continuous space-time positions that robots occupy can be approximated by the system 10 by treating the warehouse as a 4-neighbor grid and treating time as a set of discrete time points. Each position on the grid is referred to as a cell. Most cells are traversable for the robot but some cells are labeled as obstacles and cannot be traversed, we call these obstructed. Through each time period, robots are capable remaining stationary or moving to an adjacent unobstructed cell in the four main compass directions, which we connect through edges. Robots are required to avoid collisions by not occupying the same cell at any time point and not traversing the same edge in opposite directions between any successive time points. Every item is located at a unique cell. Robots incur a cost while deployed on the grid and for moving on the grid, however, they can obtain a reward for servicing an item. To service an item, a robot must travel to the specific cell where the item is located during the item's associated serviceable time window. Servicing an item consumes a portion of the robots capacity, which can be refreshed once it travels back to the launcher.

FIG. 2 is a flowchart illustrating process steps 50 carried out by the system 10 of FIG. 1. In step 52, the system retrieves automated system (e.g., robots, AGVs, etc.) location and movement data, e.g., from the database 14 of FIG. 1, from the automated systems themselves, etc. Optionally, in step 54, the location and movement data is pre-processed as noted above in connection with FIG. 1. Once pre-processed, the data is then processed by the modules 18b-18c, as described in detail below in connection with steps 56-60. Finally, in step 62, the system 10 generates one or more optimal routes based on outputs of steps 56-60 (e.g, based on outputs of a integer linear programming algorithm, a column generation algorithm, and solving of a pricing problem associated with route planning, as each of these steps are discussed in greater detail below), and transmits the routes to the automated systems 20a-20c, for execution by the automated systems 20a-20c, such that movement of the systems 20a-20c is controlled by the routes transmitted thereto.

In step 56, the system processes the location and movement data using an integer linear programming (ILP) described herein, to address multi-robot planning (MRP). The ILP problem using the following notation. We use G to denote the set of feasible robot routes, which we index by g. We note that G is too large to be enumerated. We use Γ_{g}ϵ [symbol] to denote the cost of robot route g. We use γ_{g}ϵ{0, 1} to describe a solution where g is in the solution IFF γ_{g}=1. We describe the sets of items, times, and extant robots as D, T, and R, respectively, which we index by d, t, and r, respectively. We use (P, E) to denote the time-extended graph. Every pϵP represents a space-time position, which is a pair of a location (i.e., an unobstructed cell on the warehouse grid) and a time tϵT Two space-time positions pᵢ, pⱼϵP are connected by a (directed) space-time edge e=(pᵢ; pⱼ)ϵε IFF the locations of pᵢ and pⱼ are the same cell or adjacent cells and the time of pⱼ is the time of pᵢ plus one.

We describe routes using G_{ig}ϵ{0, 1} for iϵI={D U T U P U ε U R} We set G_{dg}=1 IFF route g services item d. We set G_{tg}=1 IFF route g is active (meaning moving or waiting) at time t. We set G_{pg}=1 IFF route g includes space-time position p. We set G_{rg}=1 IFF route g is associated with extant robot r. We set G_{eg}=1 IFF route g uses space-time edge e. This edge is associated with adjacent cells e₁ and e₂ in space and time t. Thus, G_{eg}=1 indicates that a robot on route g crosses from e₁ at time t to e₂ at time t+1 OR from e₂ at time t to e₁ at time t+1. We use N to denote the total number of robots available in the fleet.

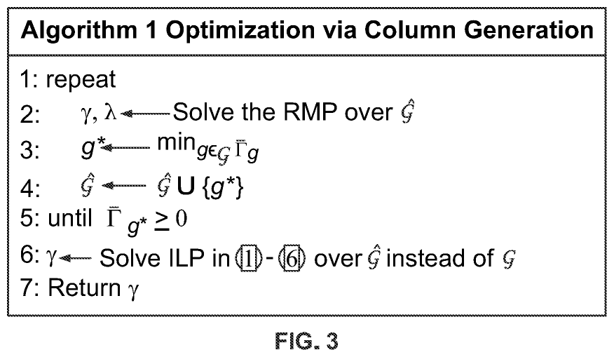

In step 58, the system optimizes the ILP algorithm using a column generation (CG) optimization algorithm. We write MRP as an ILP as illustrated in Algorithm 1 of FIG. 3, followed by an explanation of the objective and constraints.

$$\begin{matrix}{min}_{{γ}_{g} ∈ \{ 0 , 1 \} ∀ g ∈ 𝒢} {\sum }_{g ∈ 𝒢} {Γ}_{g} {γ}_{g} & ( 1 ) \\ {\sum }_{g ∈ 𝒢} {G}_{dg} {γ}_{g} \leq 1 ∀ d ∈ 𝒟 & ( 2 ) \\ {\sum }_{g ∈ 𝒢} {G}_{tg} {γ}_{g} \leq N ∀ t ∈ 𝒯 & ( 3 ) \\ {\sum }_{g ∈ 𝒢} {G}_{rg} {γ}_{g} = 1 ∀ r ∈ ℛ & ( 4 ) \\ {\sum }_{g ∈ 𝒢} {G}_{pg} {γ}_{g} \leq 1 ∀ p ∈ 𝒫 & ( 5 ) \\ {\sum }_{g ∈ 𝒢} {G}_{eg} {γ}_{g} \leq 1 ∀ g ∈ ℰ \\ Equations 1 \text{-} 6. & ( 6 )\end{matrix}$$

In Equation (1), we minimize the cost (that is, maximize the reward) of the MRP solution. In Equation (2), we enforce that no item is serviced more than once. In Equation (3), we enforce that no more than the available number of robots N is used at any given time. In Equation (4), we enforce that each extant robot is associated with exactly one route. In Equation (5), we enforce that no more than one robot can occupy a given space-time position. In Equation (6), we enforce that no more than one robot can move along any space-time edge.

We describe a set of feasibility constraints and cost terms for robot routes. First, each item dϵD can only be picked up during its time window [t⁻_{d}, t⁺_{d}]. Second, each item dϵD uses c_{d}ϵ [symbol] ₊ units of capacity of a robot. The capacity of a robot is c₀ϵ [symbol] ₊. An active robot r E R is associated with an initial space-time position p₀ᵣ (at the initial time, i.e., time 1) and a remaining capacity cᵣϵ[0, c₀].

The cost associated with a robot route is defined by the following terms. First, θ_{d}ϵ [symbol] is the cost associated with servicing item d. Second, θ₁, θ₂ϵ [symbol] ₀₊ are the costs of being on the floor and moving respectively, which depreciate the robot. Using θ_{d}, θ₁, and θ₂, we write Γ_{g}=Σ_{dϵD} G_{dg} θ_{d}+Σ_{tϵT}θ₁ G_{tg}+Σ_{eϵε}θ₂ Ge_{g}

In step 58, since in practice G cannot be enumerated, we address optimization in Equations (1)-(6) using column generation (CG). Specifically, we relax γ to be non-negative and construct a sufficient set Ĝ⊂G to solve optimization over G using CG. CG iterates between solving the LP relaxation of Equations (1)-(6) over Ĝ, which is referred to as the Restricted Master Problem (RMP), followed by adding elements to Ĝ that have negative reduced cost, which is referred to as pricing. Below we formulate pricing as an optimization problem using λ_{d}, λₜ, λᵣ, λₚ, and λₑ to refer to the dual variables over constraints of Equations (2)-(6) of the RMP respectively.

$${min}_{g ∈ 𝒢} {\overline{Γ}}_{g} where {\overline{Γ}}_{g} = {Γ}_{g} - {\sum }_{i ∈ ℐ} {λ}_{i} {G}_{ig} \qquad ( 7 )$$

We terminate optimization when the solution to Equation (7) is non-negative, which means that Ĝ is provably sufficient to exactly solve the LP relaxation of optimization over G. We initialize Ĝ with any feasible solution (perhaps greedily constructed) so as to ensure that each rϵR is associated with a route. At termination of CG, if γ_{g}ϵ{0, 1}, ∀gϵG, then the solution, i.e. the tracks defined by {gϵG|γ_{g}=1}, is provably optimal. Otherwise, an approximate solution can be produced by solving the ILP formulation over Ĝ or the formulation can be tightened using valid inequalities, such as subset row inequalities. We can also use branch-and-price to formulate CG inside a branch-and-bound formulation. Algorithm 1 of FIG. 3 shows pseudocode for CG. Below, we describe an enhanced version of CG motivated by dual optimal inequalities (DOI).

In step 58 of FIG. 2, the system 10 solves one or pricing problems associated with route planning. In this step, the system 10 considers the problem of pricing, which we show is a resource-constrained shortest-path problem (RCSP). First, we formulate pricing as an RCSP over a graph whose nodes correspond to space-time positions and whose resources correspond to the items picked up. Next, we accelerate computation by coarsening the graph, leaving only locations of significance such as item locations across time. Then, we further accelerate computation by limiting the times considered while still achieving exact optimization during pricing. Finally, we show that CG can be accelerated by updating the λᵢ for all iϵD U R more often than the remainder of the dual solution, saving computation time by precluding the need to reconstruct the coarsened graph as often between rounds of pricing.

A weighted graph admitting an injunction from the routes in G to the paths in the graph is established. For a given route g, the sum of the weights along the corresponding path in the weighted graph is equal to the route's reduced cost Γ_{g}. Thus, finding the lowest-cost feasible path in this graph solves Equation (7). The graph proposed is a modified form of the time-extended graph (P, E). Nodes are added to represent start/end locations, item pickups, and the use of an extant robot. Weights are amended by the corresponding dual variables associated with a given node/edge. We solve a RCSP over this graph where the resources are the items to be pick up.

Formally, consider a graph (P⁺, E⁺) with paths described by x_{pipjg}ϵ{0, 1} for (pᵢ, pⱼ) E ε⁺, gϵG, where x_{pipjg}=1 indicates that edge (pᵢ, pⱼ) is traversed by the path on the graph corresponding to route g. Each edge (pᵢ, pⱼ) has an associated weight κpipj. There is a node in P⁺ for each pϵP, for each pairing of dϵD and tϵ[t⁻_{d}, t⁺_{d}] denoted p_{dt}, for each rϵR denoted pᵣ, the source node p₊, and the sink node p₋. We ensure that Γ_{g}=Σ_{(pi,pj)ϵε}+^{K}ₚᵢₚⱼ^{X}_{pipjg} for all gϵG. For each pair of space-time positions pᵢ, pⱼ occurring at the same cell at times tᵢ, tⱼ=tᵢ+1 (representing a wait action), we set κₚᵢₚⱼ=θ₁−λₜⱼ−λₚⱼ. We set x_{pipig}=1 IFF robot route g transfers from pᵢ to pⱼ and no pickup is made at pᵢ.

For each pair of space-time positions pᵢ, pⱼ occurring at times tᵢ and tⱼ=tᵢ+1 and associated with space-time edge e (representing a move action), we set κₚᵢₚⱼ=θ₁+θ₂−λₑ−λₜj−λₚⱼ. We set λ_{pipjg}=1 IFF robot route g transfers from pᵢ to pⱼ and no pickup is made at pᵢ. For each dϵD, tϵ[t⁻_{d}, t⁺_{d}], which occurs at space-time position p, we set κ_{ppdt}=θ_{d}−λ_{d}. We set x_{ppdtg}=1 IFF robot route g picks up item d at time t. For each dϵD, tϵ[t⁻_{d}, t⁺_{d}] which occurs at an associated p, we provide identical outgoing κ terms for p_{dt} as we do p (except there is no self-connection p_{dt} to p_{dt}). We set x_{pdtpjg}=1 IFF robot route g transfers from the position of item d to pⱼ and item d is picked up at time tⱼ−1 on route g. For each tϵT we connect the p₊ to the launcher at time t denoted p₀ₜ with weight κₚ₊ₚ₀ₜ=θ₁−λₜ−λₚ₀ₜ. We set x_{p+p0tg}=1 IFF the robot route g appears first at p₀ₜ. For each rϵR we set κₚ₊ₚᵣ=θ₁−λᵣ−λₜ₌₁−λₚᵣ. We set x_{p+prg}=1 IFF the robot route g appears first at pᵣ. For each rϵR, pᵣ has one single outgoing connection to p₀ᵣ with weight κₚᵣₚ₀ᵣ=0.

For each tϵTwe set κₚ₀ₜₚ₋=0. We set x_{p0tp-g}=1 IFF the robot route g has its last position at p₀ₜ. Using κ defined above we express the solution to Equation (7) as an ILP (followed by description) using decision variables xₚᵢₚⱼϵ{0, 1} where xₚᵢₚⱼ is equal to x_{pipjg} for all (pᵢ, pⱼ)ϵε⁺.

$$\begin{matrix}{min}_{{x}_{{p}_{i} {p}_{j}} ∈ \{ 0 , 1 \} ∀ ( {p}_{i} , {p}_{j} ) ∈ {ℰ}^{+}} {\sum }_{( {p}_{i} , {p}_{j} ) ∈ {ℰ}^{+}} {κ}_{{p}_{i} {p}_{j}} {x}_{{p}_{i} {p}_{j}} & ( 8 ) \\ {\sum }_{( {p}_{i} , {p}_{j} ) ∈ {ℰ}^{+}} {x}_{{p}_{i} {p}_{j}} - {\sum }_{( {p}_{j} , {p}_{i} ) ∈ {ℰ}^{+}} {x}_{{p}_{j} {p}_{i}} = [ {p}_{i} = {p}_{+} ] - [ {p}_{i} = {p}_{-} ] ∀ {p}_{i} ∈ {𝒫}^{+} & ( 9 ) \\ {\sum }_{d ∈ 𝒟} {c}_{d} {\sum }_{{t}_{d}^{-} \leq t \leq {t}_{d}^{+}} {\sum }_{( p , {p}_{dt} ) ∈ {ℰ}^{+}} {x}_{{pp}_{dt}} \leq {c}_{0} + {\sum }_{r ∈ ℛ} ( {c}_{r} - {c}_{0} ) {x}_{{p}_{+} {p}_{r}} & ( 10 ) \\ {\sum }_{{t}_{d}^{-} \leq t \leq {t}_{d}^{+}} {\sum }_{( p , {p}_{dt} ) ∈ {ℰ}^{+}} {x}_{{pp}_{dt}} \leq 1 ∀ d ∈ 𝒟 & ( 11 )\end{matrix}$$

In Equation (8) we provide objective s.t. Γ_{g}=Σ_{(pi,pj)ϵε+}^{k}ₚᵢₚⱼ^{x}_{pipjg} for all gϵG. In Equation (9) we ensure that x describes a path from p₊ to p₋ across space time. In Equation (10) we ensure that capacity is obeyed. In Equation (11) we ensure that each item is picked up at most once. Optimization in Equations (8)-(11) is strongly NP-hard as complexity grows exponentially with |D|.

The optimization for pricing can be re-written in a manner that vastly decreases graph size allowing optimization to be efficiently achieved for the RCSP solver. We exploit the fact that given the space-time positions where item pick-ups occur, we can solve of the remainder of the problem as independent parts. Each such independent part is solved as a shortest path problem, which can be solved via a shortest path algorithm such as Dijkstra's algorithm.

We now consider a graph with node set P² with edge set E², decision x²_{pipjg}ϵ{0, 1} and weights κ². There is one node in P² for each pϵP⁺ excluding those for pϵP, i.e., P²=P⁺\P. For any pᵢ, pⱼϵP², (pᵢ, pⱼ)ϵε² IFF there exists a path from pᵢ to pⱼ in ε⁺ traversing only intermediate nodes that exist in P. We set κ²ₚᵢₚⱼ to be the weight of the shortest path from pᵢ to pⱼ in ε⁺ using only intermediate nodes in P. This is easily computed using a shortest path algorithm. We set x²_{pipjg}=1 IFF pᵢ is followed by pⱼ in robot route g when ignoring nodes in P. Replacing ε⁺, x with ε², x² respectively in Equations (8)-(11) we have a smaller but equivalent optimization problem permitting more efficient optimization.

The optimization in Equations (8)-(11) over ε² requires the enumeration of all dϵD, tϵ[t⁻_{d}, t⁺_{d}], which is expensive. As a result, we circumvent the enumeration of all dϵD, tϵ[t⁻_{d}, t⁺_{d}] pairs by aggregating time into sets in such a manner so as to ensure exact optimization during pricing. For every dϵD, we construct T_{d}, which is an ordered subset of the times [t⁻_{d}, t⁺_{d}+1] where T_{d} includes initially t⁻_{d} and t⁺_{d}+1 and is augmented as needed. We order these in time where T_{jd} is the j'th value ordered from earliest to latest. T_{d} defines a partition of the window [t⁻_{d}, t⁺_{d}] into |T_{d}|−1 sets, where the j'th set is defined by [T_{dj}, T_{dj+1}−1]

We use P³, ε³, κ³, x³ to define the graph and solution mapping. Here P³ consists of p₊, p₋, pᵣ ∀ᵣϵR and one node p_{dj} for each dϵD, jϵT_{d}. We define x³_{p+pdjg}=1 if route g services item d at a time in [T_{dj}, T_{dj+1}−1] as its first pick up. The remaining x terms are defined similarly over aggregated time sets. We assign each κ³ₚᵢₚₖ to be some minimum k² over the possible paths in (P², ε²) associated with pᵢ, pₖϵP³. We set κ³_{ppdj}=min_{tϵ}[T_{dj}, T_{dj+1}⁻¹]κ²_{ppdt} for all pϵ{p₊, pᵣ∀ᵣϵR}. We set κ³ₚ₊ₚᵣ=κₚ₊ₚᵣ. We set κ³_{pdjp-}=min_{tϵ}[T_{dj}, T_{dj+1}⁻¹]κ²_{pdtp-}. For any pair of unique dᵢ, dₖ and windows jᵢ, jₖ we set

$${κ}_{{p}_{{d}_{i} {j}_{i}} {p}_{{d}_{k} {j}_{k}}}^{3} = {min}_{\begin{matrix}{t}_{0} ∈ [ {𝒯}_{{d}_{i} {j}_{i}} , {𝒯}_{{d}_{i} {j}_{i} + 1} - 1 ] \\ {t}_{1} ∈ [ {𝒯}_{{d}_{k} {j}_{k}} , {𝒯}_{{d}_{k} {j}_{k + 1}} - 1 ]\end{matrix}} {κ}_{{p}_{{d}_{i} {t}_{0}} {p}_{{d}_{k} {t}_{1}}}^{2} .$$

Evaluating each of the κ³ terms amounts to solving a basic shortest path problem (no resource constraints), meaning not all κ² terms mentioned in these optimizations need be explicitly computed. Replacing ϵ⁺ with ϵ³ in Equations (8)-(11) we have a smaller optimization problem permitting more efficient optimization, which provides a lower bound on Equations (8)-(11).

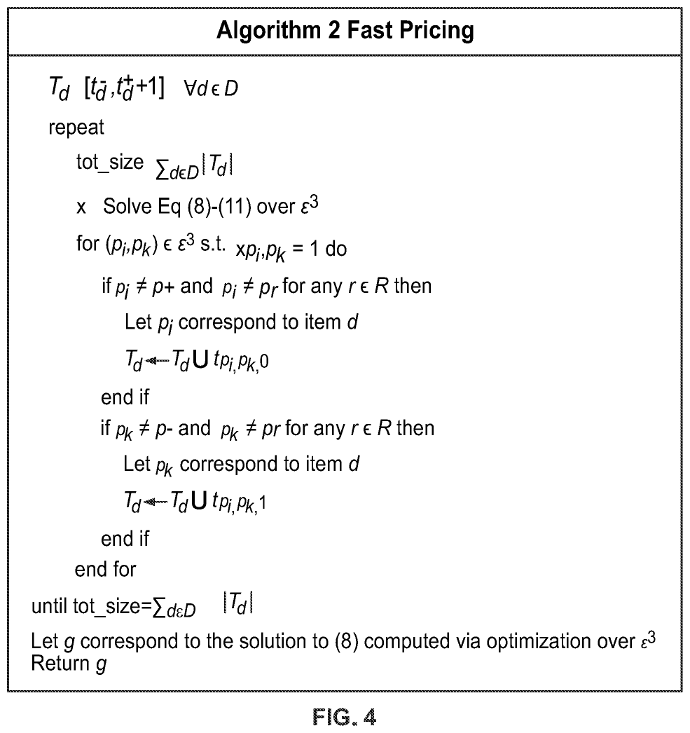

Optimization produces a feasible route when each item in the route is associated with exactly one unique time. In pursuit of a feasible route, we add the times associated with items in the route to their respective T_{d} sets. We iterate between solving the RCSP over ε³ and augmenting the T_{d} until we obtain a feasible route. This must ultimately occur since eventually T_{d} would include all tϵT for all dϵD. Though it should occur much earlier in practice. We provide pseudocode for this pricing method in Algorithm 2 illustrated in FIG. 4

Solving the pricing problem is the key bottleneck in computation experimentally. One key time consumer in pricing is the computation of the κ terms, which can easily be avoided by observing that κ², κ³ terms are offset by changes in λ_{d} and λᵣ but the actual route does not change so long as λₑ, λₚ, and λₜ are fixed. We resolve the RMP fully only periodically so that we can perform several round of pricing using different λ_{d}, λᵣ terms leaving the λₑ, λₚ, λₜ fixed.

We ran two sets of experiments to empirically study our model. In the first set, we test our model on two classes of random, synthetic problem instances, recording relevant performance and solution statistics. We examine the distribution of these results, and we compare our algorithm to a modified version employing MAPF to assess the added value of the algorithm's consideration of robot collisions in the formulation.

We study the performance of our algorithm on two distinct problem classes where each class includes a set of 100 random instances with specific, shared parameters. Each class shares the same grid size, number of time steps, number of serviceable items, number of map obstacles, and number of robots. Given a set of problem parameters, a single instance additionally includes a random set of obstacle locations, item locations and their respective demands and time windows, and extant robot start locations. We solve each instance over the class, recording the LP objective solution and solving the corresponding ILP over the column set Ĝ obtained through CG.\grave{ }und) and the lower bound (the LP objective solution) divided by the lower bound. We normalize so as to efficiently compare the gap obtained (upper bound—lower bound) across varying problem instances. Experiments are run in MATLAB and CPLEX is used as our general purpose MIP solver.

TABLE 1
10 × 10 grid results over 100 random problem instances

| | | | LP | Integral | |
|---|---|---|---|---|---|
| | Time (sec) | Iterations | Objective | Objective | Relative Gap |
| mean | 236.3 | 24.7 | −581.0 | −574.6 | .01 |
| median | 160.0 | 24 | −586.2 | −581 | .01 |

We solve the RCSP in pricing using an exponential time dynamic program. In each round of pricing we return the twenty lowest reduced cost columns we obtain, if they all have negative reduced cost. Otherwise, we return as many negative reduced cost columns as we obtain. We update λₜ, λₚ, λₑ, and the associated graph components every three CG iterations, unless we are unable to find a negative reduced cost column in a given iteration, in which case update all dual variables and rerun pricing. If at any point pricing fails to find a negative reduced cost column while all dual variables are up to date, then we have finished optimization and we conclude CG. To ensure feasibility for the initial round of CG, we initialize the RMP with a prohibitively high cost dummy route g_{r,init} for each rϵR, where all G_{dgr,init}, G_{tgr,init}, G_{pgr,init}, G_{egr,init}=0 but G_{rgr,init}=1. These dummy routes represent and active robot route and thus guarantee that Equation 4 is satisfied. They ensure feasibility, but are not active at termination of CG due to their prohibitively high cost.

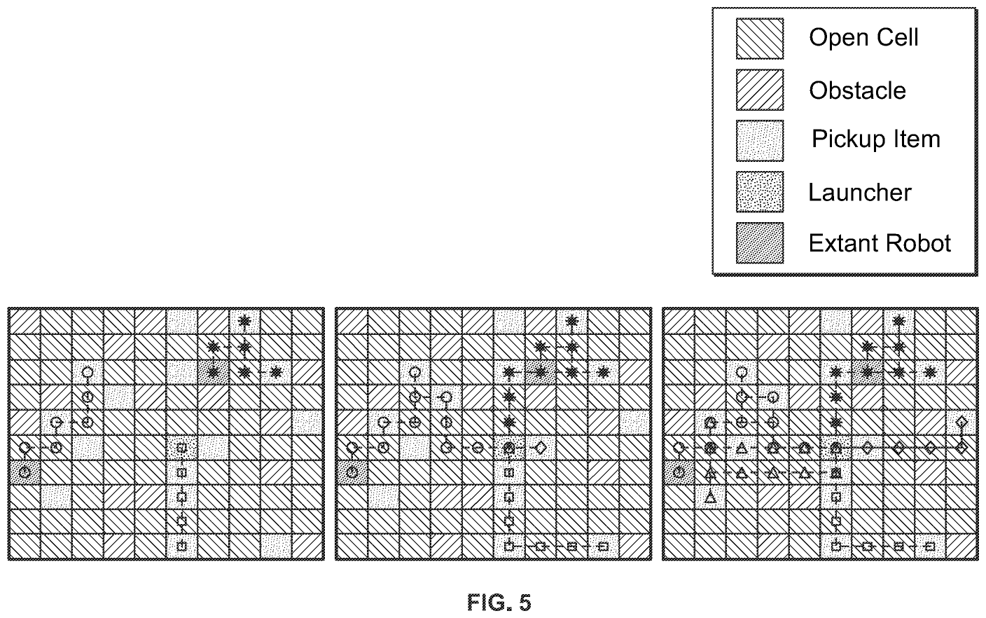

In our first class of problems we use a 10×10 grid, 4 total robots with 2 initially active, 15 serviceable items, and 30 total time steps. Each robot, including the extant ones, has a capacity of 6, while each item has a random capacity consumption uniformly distributed over the set {1, 2, 3}. We set both θ₁ and θ₂ to 1, and the reward for servicing any item, θ_{d}, is −50. Each item's time window is randomly set uniformly over the available times and can be up to 20 time periods wide. Each map has 15 random locations chosen to serve as obstacles that are not traversable. We solve 100 unique random instances and aggregate the results in Table 1 above. A sample problem with the solution routes is shown in FIG. 5. Each plot in FIG. 5 shows a snapshot in time of the same instance's solution. A snapshot shows each robot's route from the initial time up to the time of the snapshot. We see that over the problem instances in this class we have an average run time of 160 seconds requiring on average 24.7 CG iterations. We report an average LP objective of −581.0 and an average relative gap of 0.01, thus certifying that we are efficiently producing near optimal solutions. In 93 out of the 100 instances the approximate solution to Equations (1)-(6) reused robots after they returned to the launcher. In FIG. 5, robot route results are shown for a single instance over 3 snapshots in time. Each track is a robot route up through that time step. Traversable cells, obstacles, the starting/ending launcher, item locations, and extant robot locations are all noted in the legend—(Left): t=8 snapshot; (Middle): t=16 snapshot; (Right): t=30 (end time) snapshot.

In our second class of problems we use a 20×20 grid, 5 total robots with 2 initially active, 25 serviceable items, and 100 total time steps. Each robot, including the extant ones, has a capacity of 6 while each item has a random capacity consumption uniformly distributed over the set {1, 2, 3}. We set both θ₁ and θ₂ to 1 and the reward for servicing any item, θ_{d}, is −50. Each item's time window is randomly set uniformly over the available times and can be up to 8 time periods wide. Each map has 40 random locations chosen to serve as obstacles that are not traversable. We run on 100 unique random instances and aggregate the results in Table 2, below.

TABLE 2
20 × 20 grid results over 100 random problem instances

| | | | LP | Integral | Relative |
|---|---|---|---|---|---|
| | Time (sec) | Iterations | Objective | Objective | Gap |
| mean | 478.8 | 30.1 | −639.4 | −6329.5 | .02 |
| median | 389.0 | 30.0 | −643.5 | −632 | .01 |

We see in this class of instances we get an average run time of 478.8 seconds and an average of 30.1 iterations of CG. We get an average LP objective of −639.4 and a relativity gap of 0.01, again showing that we are efficiently producing near optimal solutions. In all 100 instances the approximate solution to Equations (1)-(6) reused robots after they returned to the launcher. We see a slight increase in the iterations required for the second problem class with respect to the first problem class. We see a larger growth in the time required for convergence. We expect this trend can be alleviated with the application of heuristic pricing. Heuristic pricing attacks the pricing optimization problem through the use of heuristic methods. Since we need only produce a negative reduced cost route through each round of pricing, not necessarily the minimum one, heuristic pricing can hasten CG by saving computational time. Such a heuristic would produce approximate solutions with respect to the ordering of the items but still be optimal given a particular ordering. We also see a very small increase in the relative gap on larger problem instances. Though most problems on the 20×20 grid still have a very small gap, we start to see more problems with a gap close to 5%. The relative gap can be reduced by tightening the relaxation through the use of subset row inequalities.

TABLE 3
Objective value results for both algorithms over 30 random instances.
Our full approach is labeled CG. We compare against modified CG + MAPF.

| | CG | modified CG + MAPF | Difference (CG − MAPF) |
|---|---|---|---|
| mean | −124.6 | −116.8 | −7.9 |
| median | −122.0 | −111.0 | −1.0 |

We compare our algorithm to a modified version that incorporates MAPF. This version will initially ignore robot collision constraints but ultimately consider them after a set of serviceable items are assigned to specific robots. The modified algorithm works as follows. We solve a given problem instance using our CG algorithm, but we neglect the collision constraints, meaning λₚ=0, λₑ=0, ∀ₚϵP, eϵε. This closely resembles a vehicle routing problem and delivers us a set of robot routes, including the items serviced by each robot, however this could include collisions. We then take the disjoint set of items serviced and feed them to a MAPF solver. The MAPF solver delivers a set of non-colliding robot routes, each attempting to service the set of items assigned to it. If the MAPF solver fails to provide a valid route for a particular robot (i.e., it cannot make it back to the launcher in time) that route is neglected in the algorithm's final solution.

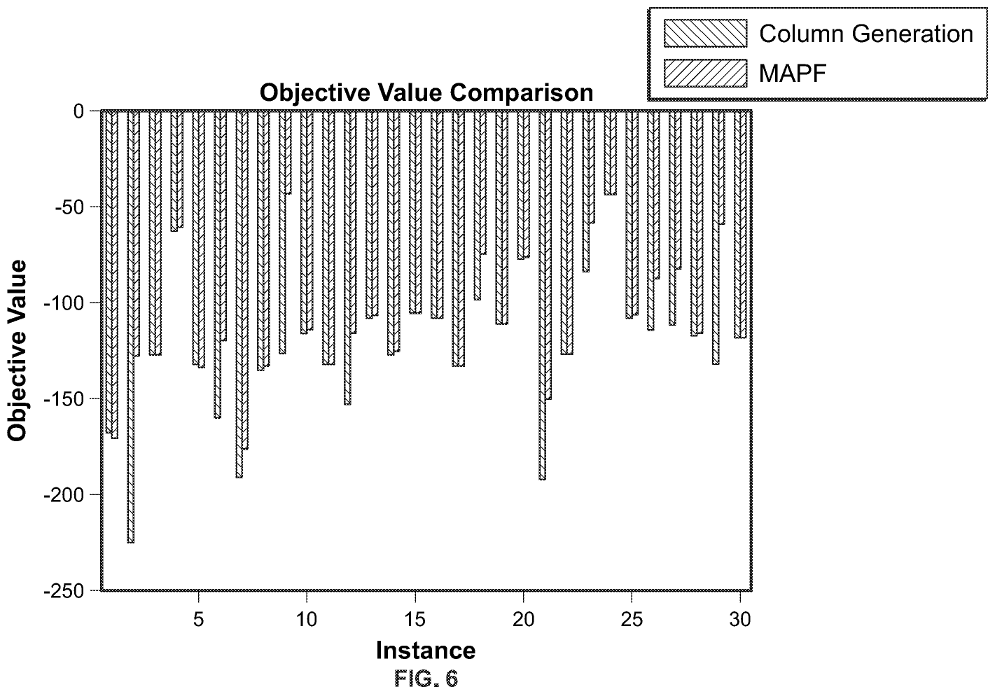

We compare the resulting objective values from our full CG approach to this modified approach. For the purposes of this comparison, we neglect time constraints for the items so as to be generous to the MAPF solver, which is not equipped to handle time windows for items. We solve 30 random instances with the same parameters. We use a 20×20 grid, 35 serviceable items, 100 random obstacles, 9 total robots, 1 extant robot, and 25 total time steps. We set θ₁ to 1, θ₂ to 0, and the reward for servicing any item, θ_{d}, to −15. The objective value results for both approaches are show in table 3. A side by side plot of the objective values are shown in FIG. 6, wherein the full CG approach is shown and compared against the modified column CG+MAPF approach.

We see an average objective difference of −7.9 and a median difference of −1.0 from the modified algorithm to our full algorithm. We note from looking at FIG. 6 that many instances deliver very similar objective results, however some show drastic improvements for our algorithm. These instances largely include robot routes that the MAPF algorithm was unable to find a complete route for within the time constraint given the potential collisions with other robots. With such problems we see it is critical to employ our full algorithm that jointly considers routing and assignment.

The systems and methods of the present disclosure unify multi-agent path finding with vehicle routing/column generation to produce a novel approach applicable to broad classes of multi-robot planning (MRP) problems. The system treats MRP as a weighted set packing problem where sets correspond to valid robot routes and elements correspond to space-time positions. Pricing is treated as a resource-constrained shortest-path problem (RCSP), which is NP-hard but solvable in practice. We solve the RCSP by limiting the time windows that need be explored during pricing. It is noted that the system can be extended to tighten the LP relaxation using subset row inequalities and to ensure integrality with branch-and-price. Subset row inequalities are trivially applied to sets over the pickup items since they do not alter the solution paths. Similarly, branch-and-price would be applied to sets over pickup items. Additionally, the system can incorporate heuristic pricing to solve the resource-constrained shortest-path problem in pricing more efficiently, thus increasing the scalability of the algorithm. The system provides insight into the structure of dual optimal solutions and the effect of smoothing. Dual values should change smoothly across space and time, encouraging solutions over the course of column generation.

Having thus described the system and method in detail, it is to be understood that the foregoing description is not intended to limit the spirit or scope thereof. It will be understood that the embodiments of the present disclosure described herein are merely exemplary and that a person skilled in the art may make any variations and modification without departing from the spirit and scope of the disclosure. All such variations and modifications, including those discussed above, are intended to be included within the scope of the disclosure. What is desired to be protected by Letters Patent is set forth in the following claims.

What is claimed is:

1. A system for controlling at least one automated system, comprising;
a database storing location and movement data of the at least one automated system; and
a processor in communication with the database, the processor programmed to:
retrieve the location and movement data from the database;
process the location and movement data using an integer linear programming algorithm;
optimize the integer linear programming algorithm using a column generation algorithm;
solve a pricing problem associated with generating routes for the at least one automated system;
generate a route based on outputs of the integer linear programming algorithm, the column generation algorithm, and solving of the pricing problem; and
transmit the route to the at least one automated system, the at least one automated system executing the route to control a location or a movement of the at least one automated system.

2. The system of claim 1, wherein the processor pre-processes the location and movement data prior to processing the location and movement data using the integer linear programming algorithm.

3. The system of claim 1, wherein the at least one automated system comprises one or more of a robot, an automated guided vehicle, or a drone.

4. The system of claim 1, wherein the location and movement data is obtained in real time from the at least one automated system.

5. The system of claim 1, wherein the location and movement data comprises space and time data.

6. The system of claim 5, wherein the integer linear programming algorithm processes the space and time data to generate a location and time pair for each of the at last one automated system.

7. The system of claim 6, wherein the integer linear programming algorithm connects location and time pairs by a space-time edge between each pair and generates a candidate route using the edges.

8. The system of claim 1, wherein the column generation algorithm establishes a set of feasibility constraints and cost terms for each route.

9. The system of claim 1, wherein the processor solves the pricing problem as a resource-constrained shortest-path problem (RCSP) over a graph whose nodes correspond to space-time positions and resources correspond to items picked up.

10. The system of claim 9, wherein the processor accelerates computation by coarsening the graph and limiting times considered by the processor.

11. A method for controlling at least one automated system, comprising the steps of:
retrieving by a processor location and movement data of at least one automated system;
processing the location and movement data using an integer linear programming algorithm executed by the processor;
optimizing the integer linear programming algorithm using a column generation algorithm executed by the processor;
solving by the processor a pricing problem associated with generating routes for the at least one automated system;
generating a route based on outputs of the integer linear programming algorithm, the column generation algorithm, and solving of the pricing problem; and
transmitting the route to the at least one automated system, the at least one automated system executing the route to control a location or a movement of the at least one automated system.

12. The method of claim 1, further comprising pre-processing the location and movement data prior to processing the location and movement data using the integer linear programming algorithm.

13. The method of claim 11, wherein the at least one automated system comprises one or more of a robot, an automated guided vehicle, or a drone.

14. The method of claim 11, wherein the location and movement data is obtained in real time from the at least one automated system.

15. The method of claim 11, wherein the location and movement data comprises space and time data.

16. The method of claim 15, wherein the integer linear programming algorithm processes the space and time data to generate a location and time pair for each of the at last one automated system.

17. The method of claim 16, wherein the integer linear programming algorithm connects location and time pairs by a space-time edge between each pair and generates a candidate route using the edges.

18. The method of claim 11, wherein the column generation algorithm establishes a set of feasibility constraints and cost terms for each route.

19. The method of claim 11, further comprising solving the pricing problem as a resource-constrained shortest-path problem (RCSP) over a graph whose nodes correspond to space-time positions and resources correspond to items picked up.

20. The method of claim 19, further comprising accelerating computation by coarsening the graph and limiting times.
